(19) United States
(12) Patent Application Publication
(10) Pub. No.: US 2026/0191140 A1
(43) Pub. Date: Jul. 9, 2026

(54) Grain Sensing

(71) Applicant: AGCO International GmbH, Neuhausen (CH)

(72) Inventor: Dan Hermann, Randers (DK)

(21) Appl. No.: 19/133,028

(22) PCT Filed: Oct. 17, 2023
(86) PCT No.: PCT/IB2023/060452

§ 371 Date: May 27, 2025

(30) Foreign Application Priority Data
Nov. 28, 2022 (GB) 2217807.3

(51) Int. Cl. A01D 41/127; G01H 11/08

(52) U.S. Cl. CPC A01D 41/1273; G01H 11/08

(57) ABSTRACT

A sensor is provided for monitoring one or more grain parameters associated with material processed by a harvesting machine. The sensor includes a sensing surface; a first transducer element operably coupled to the sensing surface and responsive, in use, to movement of the sensing surface; and a second transducer element operably coupled to the sensing surface and operable, in use, to apply a test signal to the sensing surface. The sensor response of the first transducer element to the test signal is used to determine an operational characteristic of the sensor.

### CROSS-REFERENCE TO RELATED APPLICATIONS

Not applicable.

### FIELD

Embodiments of the present disclosure relate generally to systems and methods for obtaining a measurement of a grain parameter associated with an agricultural operation.

### BACKGROUND

Self-propelled agricultural machines, specifically combine harvesters, perform multiple harvesting functions within a single machine, including picking, threshing, separating, and cleaning of crop. It is advantageous whilst performing such operations to obtain measurements of one or more grain parameters to monitor an efficiency or the like of the harvesting function, e.g. grain flow or grain loss.

For example, grain loss can occur at one or more points within the harvester, whilst performing any of the above mentioned harvesting tasks, and may occur due to incorrect operation of the machine, operating issues or damage, for example. It is therefore beneficial to be able to monitor this loss, and automate or at least prompt an operator to correct or adjust one or more operational factors to reduce this loss. For this purpose, an accurate measurement of the grain loss is advantageous. Likewise, it may also be beneficial to obtain a measure of an amount of grain entering or moving through one or more components of the machine, e.g. a machine of grain flow into the grain bin to obtain an indication of a yield of the harvesting operation or indeed a measure of the capacity of the grain bin.

Known sensors used to measure such grain parameters include “impact” or acoustic sensors, which are configured to measure the impact of grain and other material incident on a detection surface of the sensor. Grain can be distinguished from other material incident on the sensor through analysis of the signal produced upon impact of material with the detection surface. Specifically, due to the kernels of grain being much harder than the straw and chaff, impacts of the kernels with a detection surface have a characteristic sensor response, namely a fast rise time, with a generally higher amplitude when compared with sensor response associated with the impact of straw and/or chaff with the sensor. Therefore, by measuring the force and/or frequency of such impacts, and in particular those associated with grain incident on the detection surface, it is possible to determine a measurement or at least a prediction of the amount of grain present in the material being monitored.

However, such known systems are susceptible to high levels of noise given the operating environment which includes multiple operational components and significant vibration and other noise sources due to their operational nature. Accordingly, it can be difficult using known systems to reliably distinguish between grain/kernel impacts and background noise, making accurate measurement of the one or more grain parameters difficult.

It would therefore be advantageous to provide an improved impact sensor, and associated systems and methods for measuring one or more grain parameters associated with a harvesting operation.

### BRIEF SUMMARY

In an aspect of the invention there is provided a sensor for monitoring one or more grain parameters associated with material processed by a harvesting machine, the sensor comprising: a sensing surface; a first transducer element operably coupled to the sensing surface and responsive, in use, to movement of the sensing surface; a second transducer element operably coupled to the sensing surface and operable, in use, to apply a test signal to the sensing surface; and a communication unit for outputting sensor data indicative of a sensor response of the first transducer element for analysis to determine an operational characteristic of the sensor therefrom.

Advantageously, the present disclosure provides a sensor which incorporates a transducer element operable to induce a test signal (e.g. an impulse, frequency scan etc.) in the sensing surface for diagnosing one or more operational characteristics of the sensor. This may include means to determine a material build up on the sensing surface and/or malfunction of one or more components of the sensor, such as a the first transducer element, for example.

The first transducer element may be operable to output a signal indicative of a movement or vibration of the sensing surface corresponding to the location of the sensing element. The first transducer element may be operable to output a signal indicative of a movement or vibration of the sensing surface corresponding to the location of the sensing element caused by application of the test signal by the second transducer element.

The second transducer element may be additionally operable to output a signal indicative of a movement or vibration of the sensing surface corresponding to the location of the sensing element. In this way, the second transducer element may be utilised to monitor one or more material parameters with the sensor in addition to the first transducer element.

The first and second transducer elements may be substantially equally spaced with respect to the sensing surface.

The first and second transducer elements may comprise the same element. That is, the first and second transducer element may comprise a single transceiver element operable to both sense movement of the sensing surface and generate a test signal therefor. In such embodiments, the transceiver element may be operable to monitor the sensor response of the transceiver element in response to a test signal provided by the same element.

In embodiments, the sensing surface comprises a membrane defining a material facing side and a component side. The first and/or second transducer elements may be mounted or otherwise coupled to the component side of the membrane. The sensing surface may comprise an aluminium or fiberglass membrane, for example.

The first and/or second transducer elements may comprise piezoelectric transducer elements.

The sensor may comprise one or more additional transducer elements operably coupled to the sensing surface and responsive, in use, to movement of the sensing surface. For example, the sensor may comprise three additional transducer elements operably coupled to the sensing surface and responsive, in use, to movement of the sensing surface. In such embodiments, the second transducer element may be positioned substantially central on the sensing surface and substantially equidistant from the first transducer element and each of the one or more additional transducer elements. In this way, the sensor responses from each of the first transducer element and the one or more additional transducer elements to the test signal may be directly comparable.

A further aspect of the invention provides a control system for the sensor of the preceding aspect, the control system comprising one or more controllers and being configured to: generate and output a test signal for controlling output of the test signal by the second transducer element; receive sensor data indicative of the sensor response of the first transducer element to the test signal; process the sensor data to determine an operational characteristic for the sensor; and generate and output one or more control signals for controlling one or more operable components associated with the harvesting machine in dependence on the determined operational characteristic.

The one or more controllers may collectively comprise an input (e.g. an electronic input) for receiving one or more input signals. The one or more input signals may comprise sensor data indicative of the sensor response of the first transducer element. The one or more controllers may collectively comprise one or more processors (e.g. electronic processors) operable to execute computer readable instructions for controlling operational of the control system, for example, to process the sensor data and/or determine the operational characteristic therefrom. The one or more processors may be operable to generate one or more control signals for controlling operation of the one or more operable components. The one or more controllers may collectively comprise an output (e.g. an electronic output) for outputting the one or more control signals. The one or more processors may be operable to generate one or more control signals for controlling operation second transducer element for initiating the test signal. The one or more controllers may collectively comprise an output (e.g. an electronic output) for outputting the one or more control signals to the second transducer element.

The control system may be configured to: receive sensor data indicative of the sensor response of the first transducer element and each of the one or more additional transducer elements; process the sensor data to determine an overall sensor response for the sensor to the test signal; and determine the operational characteristic in dependence thereon.

The operational characteristic of the sensor may comprise a measure of material build up on the sensing surface. The control system, or one or more processors thereof, may be configured to compare the sensor response to the test signal with stored data indicative of a “clean” sensor and determine a material build up on the surface in dependence thereon, for example.

The operational characteristic may comprise a measure of the function of the first transducer element. For example, the control system or one or more processors thereof may be configured to compare the sensor response to the test signal to stored data indicative of a correctly functioning first transducer element and determine the function of the first transducer element based thereon. The operational characteristic may in some embodiments comprise a measure of the relative functionality of the first transducer element and the one or more additional transducer elements to identify any faults therewith. This may include a direct comparison of each transducer elements operation/response in real time and/or compared with stored data indicative of a “correct” operation of the transducer element(s).

The one or more operable components of the machine may comprise a user interface of or otherwise associated with the harvesting machine. In such embodiments, the control system may be configured to generate and output one or more control signals for the user interface for displaying or otherwise conveying information indicative of the determined operational characteristic to an operator of the harvesting machine. This may include notifying the operator of the operational characteristic and optionally suggest one or more corrective actions to perform. For example, this can include notifying the operator of the need to perform a cleaning operation of the sensor, or of the possibility of a transducer element fault.

A further aspect of the invention provides a system of an agricultural harvesting machine comprising the sensor and the control system of the preceding aspects. This may include one or more crop processing systems of the harvesting machine, for example. This may include a spreader tool of the harvester, or one or more implements coupled thereto—e.g. a header.

A further aspect of the invention provides an agricultural machine comprising the sensor, the control system, and/or the system of any preceding aspect of the invention. The agricultural machine may comprise a harvesting machine, such as a combine harvester, for example.

Within the scope of this application it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

One or more embodiments of the invention/disclosure will now be described, by way of example only, with reference to the accompanying drawings, in which:

FIG. 1 is a simplified cross-sectional side view illustrating a harvester embodying aspects of the present disclosure;

FIG. 2 is a schematic of an embodiment of a control system embodying aspects of the present disclosure;

FIG. 3 illustrates an embodiment of an impact sensor of the present disclosure;

FIG. 4A is a further embodiment of an impact sensor of the present disclosure;

FIG. 4B is a side cross sectional view of the impact sensor of FIG. 4A;

FIG. 5A illustrates sensor data obtained from impact sensor of FIGS. 4A and 4B;

FIG. 5B illustrates further sensor data obtained from impact sensor of FIGS. 4A and 4B;

FIG. 6 illustrates further sensor data obtained from impact sensor of FIGS. 4A and 4B;

FIG. 7 is a flowchart illustrating an embodiment of a method of the present disclosure; and

FIG. 8 is a top-down exploded view and a side view schematically illustrating an embodiment of an impact sensor of the present disclosure.

### DETAILED DESCRIPTION

The present disclosure relates, in general, to an impact sensor 50 for monitoring one or more grain parameters associated with a harvesting operation performed by an agricultural machine, e.g. a combine 10. The impact sensor 50 includes a sensing surface 52 and one or more sensing elements, here in the form of piezoelectric transducer elements 52A, 52B, ( . . . ), 54 operatively coupled to the sensing surface 52 for obtaining a measure of material impacts with the sensing surface 52, as is described herein. The present disclosure provides improvements in impact sensors of this type in the construction and/or operational use thereof.

### Harvester

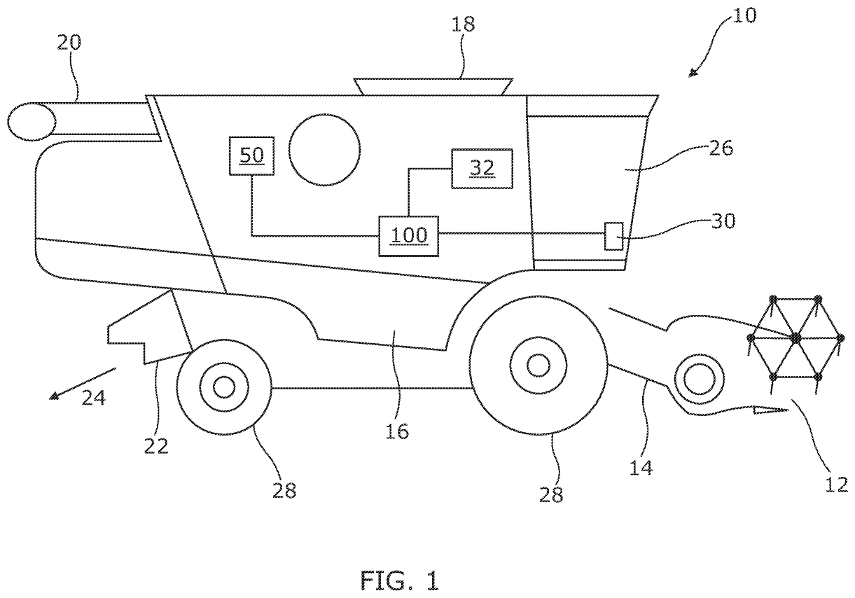

FIG. 1 illustrates an agricultural machine, and specifically a combine 10, embodying aspects of the present invention.

The combine 10 is coupled to a header 12 which is operable, in use, to cut and gather a strip of crop material as the combine 10 is driven across a field or region to be harvested during a harvesting operation. A conveyor section 14 conveys the cut crop material from the header 12 into a crop processing apparatus 16 operable to separate grain and non-grain (i.e. material other than grain (MOG), typically straw and chaff) as will be appreciated. It is noted here that apparatus for separating grain and non-grain material are well-known in the art and the present invention is not limited in this sense. The skilled person will appreciate that numerous different configurations for the crop processing apparatus may be used as appropriate. Clean grain separated from the cut crop material is collected in a grain bin 18, which may be periodically emptied, e.g. into a collection vehicle, storage container, etc. utilising unloading auger 20.

The remaining material, made up largely of non-grain material or MOG, is separately moved to a spreader tool 22 which is operable in use to eject the material from the rear of the combine 10 and onto the ground. In FIG. 1, arrow 24 illustrates the direction of the material being ejected rearwards from the combine 10.

The spreader tool 22 includes an inlet (not shown) into which material is passed from one or more further components of the combine 10. This may include material from a chopper tool provided as part of the crop processing apparatus. The spreader tool 22 additionally includes an outlet through which the material is deposited from the combine 10 and onto the field/region being harvested by the combine 10. Rotor units may be provided as part of the spreader tool 22 for providing a propulsive force for propelling the material from the spreader tool 22 and out of the combine 10. For instance, the rotor units may each include a plurality of blades which interact with the material to propel the material through an outlet of the spreader tool 22, and the speed of rotation of the rotor units may be controlled (or may be set at a predetermined level) for controlling the propulsive force provided to the material—i.e. the speed at which the material is propelled from the combine 10. Deflector plates may also be provided for controlling a direction at which the material is deposited from the combine 10.

The present disclosure relates to the use of an impact sensor 50 provided within a material flow of or otherwise associated with the combine 10 (e.g. the flow of material from spreader tool 22) for determining one or more crop parameters therefrom.

### Impact Sensor (Improved SNR)

FIG. 3 illustrates an embodiment of an impact sensor 50 according to the present disclosure.

The impact sensor 50 comprises a sensing surface 52 and a pair of sensing elements in the form of piezoelectric sensing elements 54a, 54b operatively coupled to the sensing surface 52. The piezoelectric elements 54a, 54b are operable in use to detect vibration or other movement of the sensing surface 52, e.g. caused by material impact with the surface, in use. Specifically, in use, the piezoelectric elements 54a, 54b are configured to respectively measure an impact parameter indicative of a force and/or frequency of material incident on the sensing surface 52. Grain can be distinguished from other material incident on the sensing surface 52 through analysis of the signal produced upon impact of material therewith. In general, due to the kernels of grain being much harder than straw and/or chaff, impacts of grain kernels with a detection surface have a characteristic sensor response, namely a fast rise time, with a generally higher amplitude when compared with sensor response associated with the impact of straw and/or chaff. Therefore, by measuring the force and/or frequency of such impacts, and in particular those associated with grain incident on the sensing surface 52, it is possible to determine a measurement or at least a prediction of the amount of grain present in the material.

Utilising two piezoelectric elements 54a, 54b, sensor responses at both elements 54a, 54b can be used to better account for background noise and in turn more reliably identify material impacts with the sensing surface 52. By their very nature, harvesting processes performed by combine 10 are inherently noisy with multiple moving mechanical assemblies for gathering crop, separating grain and removing material other than grain (MOG) from the collected material. Such processes are also oscillatory inherently inducing vibrational noise. This noise can obscure material impacts when using impact sensors of the type described herein. The impact sensor 50 advantageously addresses such issues.

As discussed, the sensor 50 includes a pair of piezoelectric elements 54a, 54b operatively coupled to the sensing surface 52. By comparing the sensor response of the piezoelectric elements 54a, 54b (e.g. summing and multiplying the signals), individual material impacts with the surface 52 can be more positively identified by improving the signal to noise ratio (SNR) of the sensor setup. This utilises the assumption that the background noise is roughly consistent in terms of amplitude and frequency, and substantially equal across both piezoelectric elements 54a, 54b and therefore by comparing the signals in this manner the background noise can be reduced in the output. By separating the piezoelectric elements 54a, 54b in terms of position with respect to the sensing surface 52, the sensor response for each element 54a, 54b will be different depending on the location of impact on the sensing surface 52. For instance, material impacts closer to piezoelectric element 54a compared with element 54b will result in a larger amplitude response in piezoelectric element 54a which occurs earlier in time when compared with the sensor response from element 54b. Accordingly, the sensor response for each piezoelectric element 54a, 54b is maintained even following the background removal process discussed herein.

Reduction of the SNR advantageously allows for a more accurate identification of material impacts with the sensing surface 52. However, in addition an increased capacity (i.e. detection rate) for the sensor 50 can be achieved. As discussed, the sensor response for each element 54a, 54b is also dependent on the location of the impact on the sensing surface 52. Accordingly, the presently described setup may additionally provide a means to detect the location of a given impact in dependence on the sensor response for each of the piezoelectric elements 54a, 54b. For certain setups, the impact sensor 50 may therefore be advantageously used to determine a distribution of material across the sensing surface 52. This may be used, for example, as a means to detect a distribution of material in a material flow associated with one or more components of the combine 10. In an extension, and as discussed herein, the present disclosure extends to control over one or more operable components of the combine 10 on the basis of data obtained by the impact sensor 50, e.g. to control the determined material distribution.

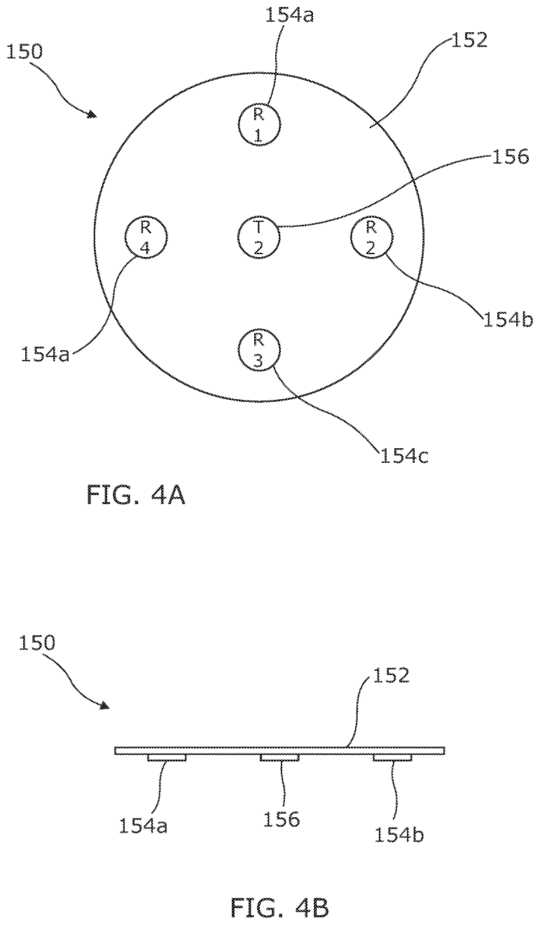

FIGS. 4A and 4B illustrate a further embodiment of an impact sensor 150 in accordance with the present disclosure.

Impact sensor 150 additionally includes two further piezoelectric elements 154c, 154d in addition to piezoelectric elements 154a, 154b which are comparable to elements 54a, 54b of impact sensor 50 and operate in the same manner as discussed above—that is they are receiving elements operable to produce a sensor response caused by a vibration the sensing surface 152 of the sensor 150 indicative of one or more material impacts with the surface. Incorporating two additional piezoelectric elements improves the SNR further due to the increased signal level obtained from four sensing elements compared with two. The illustrated embodiment further provides the advantages discussed herein in terms of capacity gains and being able to detect a location of material impacts on the sensing surface 152.

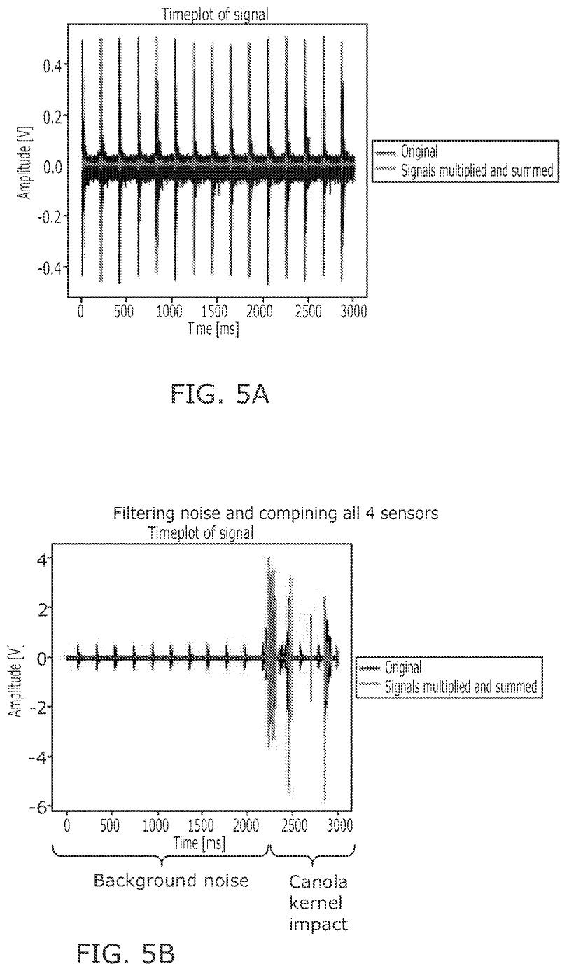

FIGS. 5A & 5B illustrate sensor data obtained by the impact sensors, 50, 150 following analysis of the sensor response from each of the piezoelectric elements 154a, 154b, 154c, 154d.

In FIG. 5A, two plots are shown to demonstrate how the background noise can be removed with the illustrated arrangement. Specifically, the “original” plot show the sensor response from a single piezoelectric element 154a during a conventional operation of harvester 10. Here, the noise present in the sensor response is as a result of the operation of the cleaning system shaker of the combine 10, operating at 5 Hz. This is presented as a +/−0.5V response in the signal obtained by piezoelectric element 154a. The second plot in FIG. 5A illustrates the resultant sensor response from impact sensor 150 when the signals from each of the piezoelectric elements 154a, 154b, 154c, 154d are multiplied and summed in the manner discussed herein. As shown, the resultant response from the sensor 150, and hence the background noise is reduced by around a factor of 10 in this manner.

FIG. 5B illustrates the sensor response for impact sensor 150 when exposed to canola kernels. As shown, the sensor response is considerably larger in amplitude when compared with the adjusted background noise. In fact, in summing and multiplying the signals from each element 154a, 154b, 154c, 154d an improved in SNR of a factor of around 20 can be achieved. In this manner, the impact sensors 50, 150 of the present disclosure and described herein advantageously overcome issues with background noise when using impact type sensors to monitor grain flow in agricultural machinery such as combine 10.

As shown in FIGS. 4A and 4B, impact sensor 150 additionally includes a further piezoelectric element 156 positioned substantially centrally with respect to the sensing surface 152. The element 156 may be advantageously used as a transmitter element in the manner discussed hereinbelow.

### Impact Sensor (Diagnostics)

The impact sensors 50, 150 are arranged in some embodiments such that they may additionally be used to self-diagnose material buildup on the sensing surface 52, 152 and/or malfunction of one or more elements of the sensor 50, 150.

Specifically, in a variant of sensor 50, at least one of piezoelectric elements 54a, 54b may function as a transmitter element in addition or as an alternative to a receiver element. For example, in one embodiment piezoelectric element 54a comprises a receiver element and piezoelectric element 54b comprises a transceiver element operable to receive a vibrational signal in the manner discussed herein but also to transmit a test signal to the sensing surface 52 when operating in a diagnostics mode. When operating in this mode, a test signal is provided to the sensing surface 52 by the transmitter element 54b and the response is analysed at piezoelectric element 54a. When a high level of material buildup is present on the sensing surface 52 the surface itself may not vibrate to the same extent upon further material impacts with the surface. Hence, the sensor response at piezoelectric element 54a is damped. This may reduce the effectiveness and responsiveness of the sensor 50, and hence it may be advantageous to monitor for such a material build up and take action in dependence thereon. Accordingly, in this variant, sensor 50 is operable in the diagnostics mode to determine a level of material build up on the sensing surface 52 and optionally initiate one or more actions in dependence thereon.

In an extension, the diagnostics mode may additional be used to diagnose issues with one or more components of the sensor 50. For instance, in applying the signal at element 54b and comparing the sensor response at element 54a with an expected response, a means is provided to determine whether the element 54a is operating correctively, e.g. if it is known that the sensing surface 52 is clear of material.

Sensor 150 includes a piezoelectric element 156 which is configured as a transmitter element 156 spaced substantially equidistant from each of the receiving elements 154a, 154b, 154c, 154d, but otherwise operates in substantially the same manner as the variant of sensor 50 discussed herein. The advantage of having a centrally positioned transmitter element 156 is that operation of each individual element 154a, 154b, 154c, 154d can be monitored and compared with the other elements 154a, 154b, 154c, 154d. Given the equidistant placing of the elements, the sensor response at each element 154a, 154b, 154c, 154d should be roughly the same for a given test signal provided by the transmitter element 156. Accordingly, the setup of sensor 150 may advantageously provide a self-diagnostic arrangement for monitoring operation of each of the piezoelectric elements 1154a, 154b, 154c, 154d.

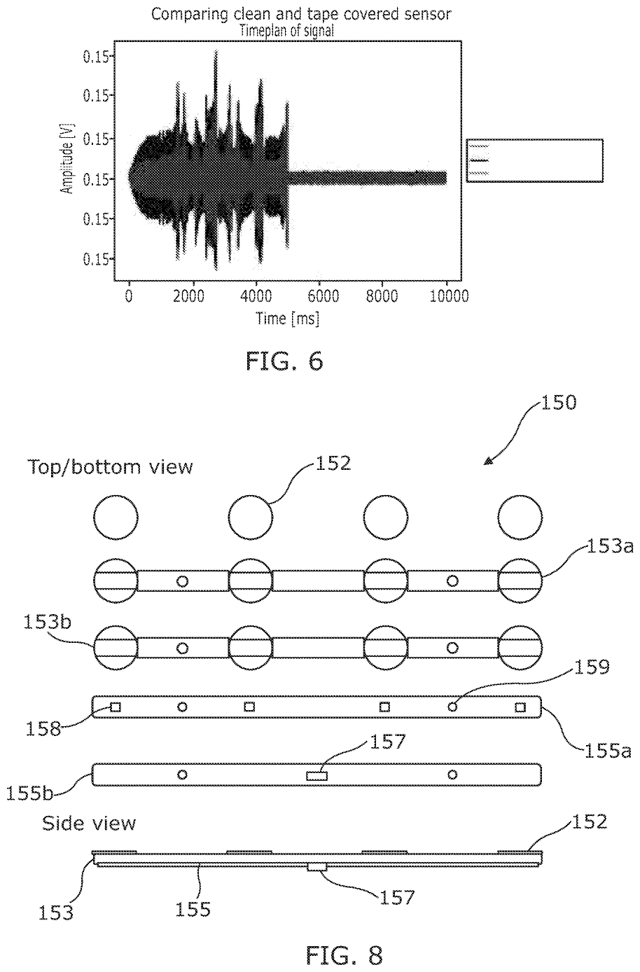

FIG. 6 illustrates the operational use of sensor 50 in the diagnostics mode discussed herein. Specifically, FIG. 6 illustrates 3 plots of the sensor response over time of element 54a illustrating the difference in sensor response for a “clean” sensor and a sensor where the sensing surface 52 has been covered with tape to imitate material buildup on the surface 52. It is shown how much of a reduction is found when material has built up on the sensing surface 52. Accordingly, the present invention utilises this information to provide a sensor 50, 150 capable of self-diagnosing such a condition, and optionally taking steps to address this issue-see below.

### Impact Sensor (Construction)

FIG. 8 illustrates an example construction for impact sensor 150 illustrating an additional advantage provided by impact sensors 50, 150 of the present disclosure.

Specifically, sensor 150 comprises a layered construction having a sensing surface/membrane 152 figuratively shown in FIG. 8 at the locations of piezoelectric elements 154a, 154b, etc. The membrane 152 is overlaid on a housing 153 having upper housing surface 153a and a lower housing surface 153b, housing piezoelectric elements 154a, 154b, etc. An upper printed circuit board surface 155a having electronic components printed and/or mounted thereon provides power and control to the piezoelectric elements via connectors 158, which may be wired connectors or form wireless power modules for the elements. A rear circuit board surface 155b incorporates a communication module 157 providing an electrical connection for powering the sensor 105 and providing a communication channel to the CAN-bus or other operational network of the combine 10 for controlling operation of the sensor 150 and for the transfer of sensor data therefrom. Holes 159 are provided in the layers for machining the sensor 150.

Advantageously, circuit board, and in particular to the rear thereof closes the rear side of the sensor and seals the componentry located/printed on the boards. This ensures that the sensor 150 can be used in the intended agricultural operation environment in contact with grain and other material and prevent dust, moisture and the like from entering and disrupting the sensor 150. The housing 153 provides a layer of protection on the material facing side of the sensor 150 for absorbing forces associated with material impacts with the sensing surface/membrane 152.

The presently described arrangement advantageously provides a thin, lightweight sensor which is sealed and easily mountable for use at multiple different locations throughout the combine 10 for monitoring one or more grain parameters, for example.

### Control System

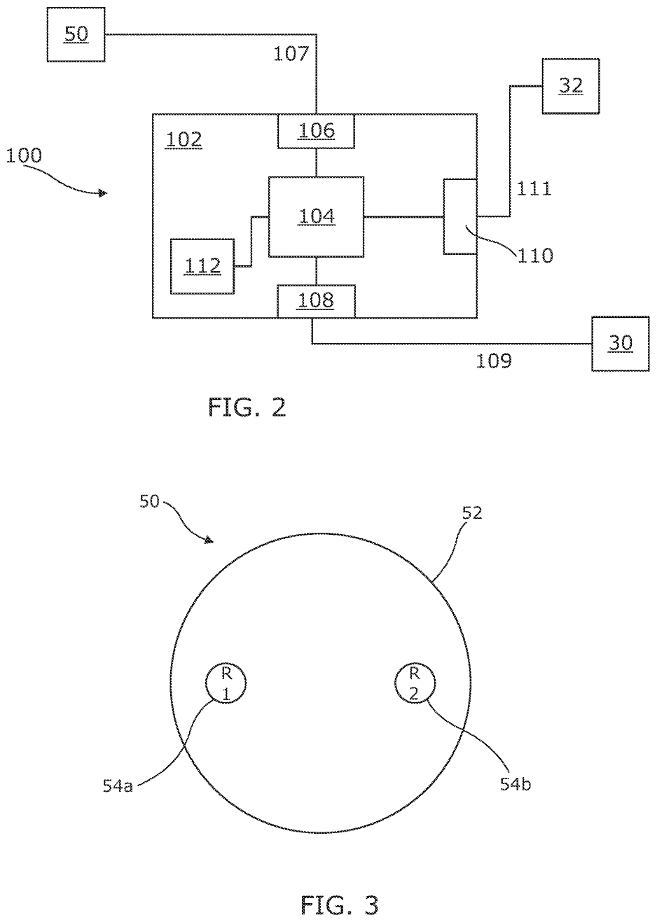

FIG. 2 is a schematic illustration of an embodiment of a control system 100 in accordance with the invention, and its functionality within a wider system for agricultural machines (e.g. combine 10). As discussed herein, the control system 100 is operable to control one or more operational parameters of the combine 10 and/or one or more components thereof (e.g. crop processing apparatus 16, header 12, components of header 12, spreader tool 22, etc.) in dependence on a determined grain parameter, e.g. as determined in the manner described herein using impact sensor 50.

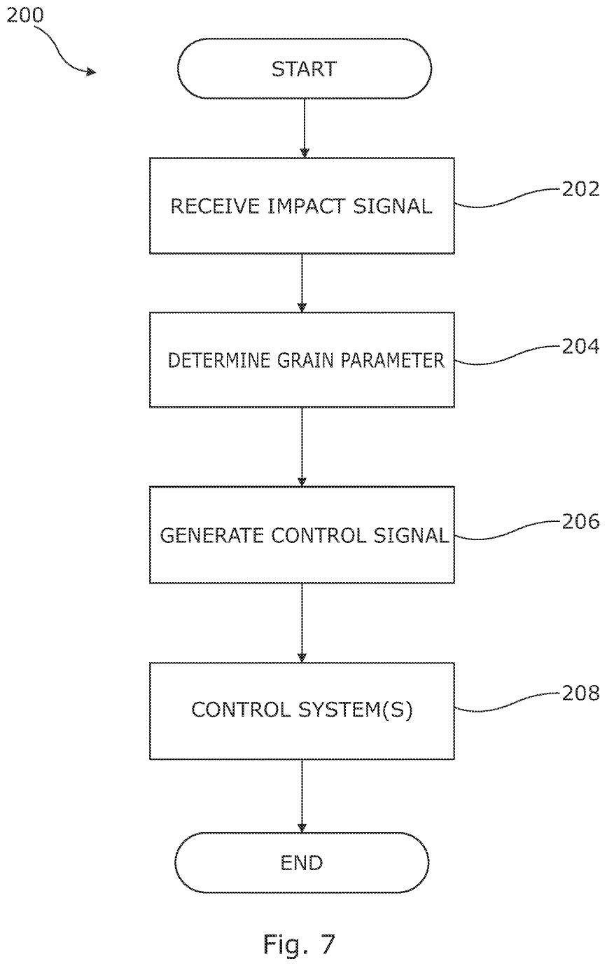

Here, the control system 100 comprises a controller 102 having an electronic processor 104, an electronic input 106, electronic outputs 108, 110 and memory 112. The processor 104 is operable to access the memory 110 and execute instructions stored therein to perform given functions, specifically to cause performance of the method 200 of FIG. 7 in the manner described hereinabove, and ultimately generate and output a control signal(s) 109, 111 from respective outputs 108, 110 for controlling operation of one or more operational parameters of the combine 10 following analysis of data from one or more impact sensors 50.

In the illustrated embodiment, the processor 104 is operable to receive an impact signal from the impact sensor 50, where the impact signal comprises data indicative of an impact parameter indicative of a force and/or frequency of material incident on the sensing surface 52 of the impact sensor 50, and determined through piezoelectric elements 54a, 54b, etc., in the manner described herein. The impact signal is provided via a communication channel between a communication unit of the sensor 50 and the electronic input 106 of the controller 102, specifically in the form of input signals 107 received at electronic input 106 of controller 102.

Processor 104 is operable to analyse the impact signals to determine the one or more grain parameters therefrom. Specifically, the processor 104 is operable to sum and/or multiply the sensor response for each of the piezoelectric elements 54a, 54b in order to determine an overall sensor response for sensor 50. As discussed in, processing the sensor data in this manner can improve the SNR of the sensor by reducing the background component of the sensor response whilst also increasing the contribution provided by material impacts on the sensing surface 52 detected at multiple elements 54a, 54b. Processor 104 is then operable to determine the grain parameter(s) in dependence on the overall sensor response. As discussed herein, the grain parameter(s) can include a measure of grain loss, an impact rate (e.g. impacts per unit time) and/or a measure of a distribution of material across the sensing surface 52.

The control signals 109 are output via electronic output 108 to a local control unit associated with a user interface 30 of the combine 10 for display of the one or more grain parameters determined from the sensor data receiving from impact sensor 50. This may include, for example, an indication of a level of grain loss associated with one or more crop processing systems of the combine 10, or a measure of grain flow, grain tank fill level etc. Control signals 111 are output via electronic output 110 to a local control unit associated with an operable component 32 of the combine 10, here associated with the header 12, and is operable to control operation of the header 12, e.g. by controlling an operational speed of the header 12 or one or more components thereof, for example. As discussed, in this manner the control system 100 of the present disclosure may be operable to use grain information as determined from the impact sensor 50 for controlling operation of one or more components. Where impact sensor 50 is utilised as a loss sensor, the one or more components of the combine 10 may be automatically controlled in response to the grain loss determined by that sensor 50 in an attempt to reduce that loss.

In a further variant, the processor 104 is operable to control impact sensor 50, 150 in a diagnostics mode as discussed herein. In such a variant, electronic input 106 comprises an input/output device operable to output one or more control signals 107 for controlling operation of the sensor 50, 150 in the diagnostics mode, specifically by causing piezoelectric element 54b, 156 to provide a testing signal to the sensing surface 52, 152. The sensor response from piezoelectric element 54a, 154a, 154b, 154c, 154d is then monitored to diagnose any issues with the sensor 50, 150. As with the embodiment discussed hereinabove, input signals 107 are received at electronic input 106 of controller 102 and processed by the processor 104 to determine the sensor response from element 54a, 154a, etc. and diagnose any issues therewith. For example, where a material buildup on the sensor surface 52, 152 is determined, control signals 109 are output via electronic output 108 to a local control unit associated with the user interface 30 of the combine 10 for display of an instruction to an operator of the combine 10 of the need to clean the sensing surface 52, 152. Where an abnormal sensor response is identified from element 54a, 154q, etc., control signals 109 are output via electronic output 108 to a local control unit associated with the user interface 30 of the combine 10 for display of an instruction to an operator of the combine 10 of the need to further investigate a potential issue with sensor 50, 150 and optionally direct/notify the operator of a particular sensing element 154a, 154b, 154c, 154d which is determined to be faulty.

### Method

An embodiment of a method 200 of the present disclosure is illustrated in FIG. 7. As discussed herein, the present disclosure extends to use of the impact sensors 50, 150 discussed herein to obtain a measure of one or more grain parameters in the manner discussed herein, and optionally utilising that data for controlling one or more subsystems of the combine 10, including a user interface 30, header 12 and the like in response to the determined grain parameter.

At step 202, an impact signal is received from the impact sensor 50 and is utilised to determine a grain parameter associated with the harvesting process. Specifically here, a measure of grain loss is obtained by mounting the sensor 50 in a flowpath associated with the spreader tool 22 of combine 10. By mounting the sensor 50 here, a measure of the amount of grain within the material passing through the spreader tool 22 can be obtained and hence, a measure of grain being lost out of the back of the combine 10.

At step 204, the impact signal is analysed to extract an impact parameter indicative of a force and/or frequency of material incident on the sensing surface 52 of the impact sensor 50. As discussed herein, through analysis of the transceiver response from impact sensor 50, individual grain impacts on the sensing surface 52 of the impact sensor 50 can be identified, and a measure of grain loss determined therefrom. This may include a count of the number of grain impacts per unit time as a measure of an amount of grain in the material being spread by the spreader tool 22, for example.

Using the measurement of grain loss, one or more systems of the combine 10 and/or an implement (e.g. header 12) coupled thereto may be controlled based thereon (steps 206 and 208). Specifically, in step 206, a control signal is generated for controlling operation of the one or more systems in a desired manner, and at step 208, this control signal is output to, for example, a control unit associated the relevant system(s) to be controlled for controlling operation of those system(s) in the desired manner.

In the illustrated embodiments, the method 200 includes outputting a control signal to a control unit associated with the user interface 30, taking the form of a display screen located within the cab 26 for outputting information and/or indicators to an operator of the combine 10 of the determined grain loss, which may include a value and/or one or more suggested corrective actions to be taken to reduce the grain loss.

In an extension, and in order to actively reduce the grain lost during a harvesting process, the method 200 and in particular step 208 of the method 200 may include controlling an operational speed of one or more systems of the combine 10. For example, the method 200 may include reducing a forward speed of the combine 10 in dependence on the determined grain loss. To achieve this, the method 200 includes outputting a control signal to an operational control unit associated with the combine 10, e.g. an ECU of the combine 10 responsible for controlling application of a motive force to the wheels 28, either through control of a power unit of the combine 10, and/or control of an associated transmission, for example. The operational control unit may additionally be operable to control operation of the crop processing apparatus 16, for example, to control an operational speed of the apparatus 16 which may dictate a speed of or volume of material which moves through the combine 10.

Additionally or alternatively, method 200 can include outputting a control signal to a control unit associated with spreader tool 22, for controlling operation thereof, e.g. to control an operational speed of components thereof, for example. In a variant, the method 200 may include receiving an operational signal from the control unit indicative of an operational speed of the spreader tool, for example, and using this information to determine the grain loss. Advantageously, the operational speed of the spreader tool 22 may be indicative of the likely speed of material through an outlet of the spreader tool 22, and may be used to identify grain impacts on the sensing surface 52 based thereon.

In a further variant, the method 200 may include controlling an operational speed of the header 12 or components thereof, e.g. one or more reels, augers, conveyors, belts and the like, or other implement suitably coupled to the combine 10 in dependence on the determined grain loss. Additionally or alternatively, the method 200 may include controlling a height, position, orientation, etc. of the header 12 or one or more components thereof in dependence on the determined grain loss.

### General

Both sensor 50 and sensor 150 comprise sensing elements in the form of piezoelectric sensing elements 54a, 54b, etc. However, it will be appreciated that the invention is not limited in this sense. Rather, the present disclosure extends to the use of other transducer-type sensing element types operable to transduce movement of the sensing surface due to material impacts with the surface into an electrical signal for processing by control system 100 or the like.

Any process descriptions or blocks in flow diagrams should be understood as representing modules, segments, or portions of code which include one or more executable instructions for implementing specific logical functions or steps in the process, and alternate implementations are included within the scope of the embodiments in which functions may be executed out of order from that shown or discussed, including substantially concurrently or in reverse order, depending on the functionality involved, as would be understood by those reasonably skilled in the art of the present disclosure.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as set out herein and a machine readable storage storing such a program. Still further, embodiments of the present invention may be conveyed electronically via any medium such as a communication signal carried over a wired or wireless connection and embodiments suitably encompass the same.

All references cited herein are incorporated herein in their entireties. If there is a conflict between definitions herein and in an incorporated reference, the definition herein shall control.

1. A sensor for monitoring one or more grain parameters associated with material processed by a harvesting machine, the sensor comprising:
a sensing surface;
a first transducer element operably coupled to the sensing surface and responsive, in use, to movement of the sensing surface;
a second transducer element operably coupled to the sensing surface and operable, in use, to apply a test signal to the sensing surface; and
a communication unit for outputting sensor data indicative of a sensor response of the first transducer element for analysis to determine an operational characteristic of the sensor therefrom.

2. A sensor as claimed in claim 1, wherein the first transducer element is operable to output a signal indicative of a movement or vibration of the sensing surface corresponding to the location of the sensing element.

3. A sensor as claimed in claim 2, wherein the first transducer element is operable to output a signal indicative of a movement or vibration of the sensing surface corresponding to the location of the sensing element caused by application of the test signal by the second transducer element.

4. A sensor as claimed in claim 1, wherein the two or more transducer elements are substantially equally spaced with respect to the sensing surface.

5. A sensor as claimed in claim 1, wherein the sensing surface comprises a membrane defining a material facing side and a component side.

6. A sensor as claimed in claim 5, wherein the first and second transducer elements are mounted or otherwise coupled to the component side of the membrane.

7. A sensor as claimed in claim 5, wherein the sensing surface comprises an aluminum membrane.

8. A sensor of claim 1, wherein the first and/or second transducer elements comprise piezoelectric transducer elements.

9. A sensor of claim 1, comprising one or more additional transducer elements operably coupled to the sensing surface and responsive, in use, to movement of the sensing surface.

10. A sensor of claim 9, comprising three additional transducer elements operably coupled to the sensing surface and responsive, in use, to movement of the sensing surface.

11. A sensor of claim 9, wherein the second transducer element is positioned substantially central on the sensing surface and substantially equidistant from the first transducer element and each of the one or more additional transducer elements.

12. A control system for the sensor of claim 1, the control system comprising one or more controllers and being configured to:
generate and output a test signal for controlling output of the test signal by the second transducer element;
receive sensor data indicative of the sensor response of the first transducer element to the test signal;
process the sensor data to determine an operational characteristic for the sensor; and
generate and output one or more control signals for controlling one or more operable components associated with the harvesting machine in dependence on the determined operational characteristic.

13. A control system of claim 12, wherein:
the sensor comprises one or more additional transducer elements operably coupled to the sensing surface and responsive, in use, to movement of the sensing surface; and wherein the one or more controllers are configured to:
receive sensor data indicative of the sensor response of the first transducer element and each of the one or more additional transducer elements;
process the sensor data to determine an overall sensor response for the sensor to the test signal; and
determine the operational characteristic in dependence thereon.

14. A control system of claim 12, wherein the operational characteristic of the sensor comprises a measure of material build up on the sensing surface.

15. A control system of claim 12, where operational characteristic comprises a measure of the function of the first transducer element.

16. A control system of claim 13, wherein the operational characteristic comprises a measure of the relative functionality of the first transducer element and the one or more additional transducer elements to identify any faults therewith.

17. A control system of claim 12, wherein the one or more operable components comprises a user interface of or otherwise associated with the harvesting machine; and the control system is configured to generate and output one or more control signals for the user interface for displaying or otherwise conveying information indicative of the determined operational characteristic to an operator of the harvesting machine.

18. A system comprising:
a sensor for monitoring one or more grain parameters associated with material processed by a harvesting machine, the sensor comprising:
a sensing surface,
a first transducer element operably coupled to the sensing surface and responsive, in use, to movement of the sensing surface,
a second transducer element operably coupled to the sensing surface and operable, in use, to apply a test signal to the sensing surface, and
a communication unit for outputting sensor data indicative of a sensor response of the first transducer element for analysis to determine an operational characteristic of the sensor therefrom; and
a control system for the sensor, the control system comprising one or more controllers and being configured to:
generate and output a test signal for controlling output of the test signal by the second transducer element,
receive sensor data indicative of the sensor response of the first transducer element to the test signal,
process the sensor data to determine an operational characteristic for the sensor, and
generate and output one or more control signals for controlling one or more operable components associated with the harvesting machine in dependence on the determined operational characteristic.

19. An agricultural machine comprising the sensor of claim 1.
